(19) United States
(12) Patent Application Publication
(10) Pub. No.: US 2010/0135103 A1
(43) Pub. Date: Jun. 3, 2010

(54) VIBRATORY APPARATUS WITH ANTI-STICK DECK SECTION

(75) Inventors: Oscar L. Mathis, JR., Cary, IL (US); Arie Dijkshoorn, Sprang-Capelle (NL)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: GENERAL KINEMATICS CORPORATION, Crystal Lake, IL (US)

(21) Appl. No.: 12/493,833

(22) Filed: Jun. 29, 2009

Related U.S. Application Data
(60) Provisional application No. 61/077,141, filed on Jun. 30, 2008.

(51) Int. Cl. B01F 11/00

(52) U.S. Cl. 366/114

(57) ABSTRACT

A vibratory apparatus includes a trough having side walls, and a deck section having a deck plate defining at least in part a deck and side walls, the side walls of the deck section resiliently coupled to the side walls of the trough. The apparatus also includes a primary vibratory generator coupled to the trough, the primary vibratory generator operating a first frequency and a first amplitude, and a secondary vibratory generator coupled to the deck section, the secondary vibratory generator operating at a second frequency and a second amplitude, the second frequency being higher than the first frequency and the second amplitude being smaller than the first amplitude.

This application claims the benefit of U.S. application No. 61/077,141, filed Jun. 30, 2008, which is hereby incorporated by reference in its entirety in the present application.

### BACKGROUND

This patent is directed to a vibratory apparatus, and, in particular, to a vibratory apparatus with a deck section having a mechanism for limiting the adhesion of materials to the deck.

Certain materials have a tendency to adhere to a surface along which it is transported, as well as to itself. Some materials may have a natural or inherent tendency to adhere. For other materials, the manner in which the material is processed or the conditions under which it is processed may influence a material's tendency to adhere. Often, it is a combination of factors.

The tendency of a material to adhere to a surface can be particular troublesome for surfaces used for separating materials, such as screens. The material can adhere to the screen and to itself, causing the openings in the screen to become occluded. As the openings in the screen become more and more occluded, the performance of the screen may suffer. If the occlusion becomes significant enough, the screen may cease to function.

As a consequence, it is known to use anti-stick coatings on transport surfaces and screens to inhibit the tendency of materials to adhere to the surface. However, this has not been found to be a complete solution to the problem. For example, the material transported across the surface may act to damage or remove the coating. Debris and foreign matter transported along the surface may have a similar, or worse, effect on the coating. The operating conditions (moisture, temperature, etc.) may also decrease the life of the coating. Repair or replacement of the coating may be required, resulting in lost operating time for the equipment.

As set forth in more detail below, the present disclosure sets forth an improved assembly embodying advantageous alternatives to the conventional devices and methods discussed above.

### SUMMARY

In one aspect, a vibratory apparatus includes a trough having side walls, and a deck section having a deck plate defining at least in part a deck and side walls, the side walls of the deck section resiliently coupled to the side walls of the trough. The apparatus also includes a primary vibratory generator coupled to the trough, the primary vibratory generator operating a first frequency and a first amplitude, and a secondary vibratory generator coupled to the deck section, the secondary vibratory generator operating at a second frequency and a second amplitude, the second frequency being higher than the first frequency and the second amplitude being smaller than the first amplitude.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a side view of a vibratory apparatus according to the present disclosure;

FIG. 2 is an partial, perspective view of a vibratory apparatus according to the present disclosure;

FIG. 3 is a side, cross-sectional view of a finger screen that may be used to define the deck of the vibratory apparatus of FIG. 1;

FIG. 4 is a partial plan view of the finger screen of FIG. 3;

FIG. 5 is a perspective view of another vibratory apparatus according to the present disclosure;

FIG. 6 is a partial, enlarged side view of a deck section of the vibratory apparatus of FIG. 5; and

FIG. 7 is an enlarged view, in partial cross-section, of a coupling between a deck section and the trough, taken about line 7-7 in FIG. 5.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

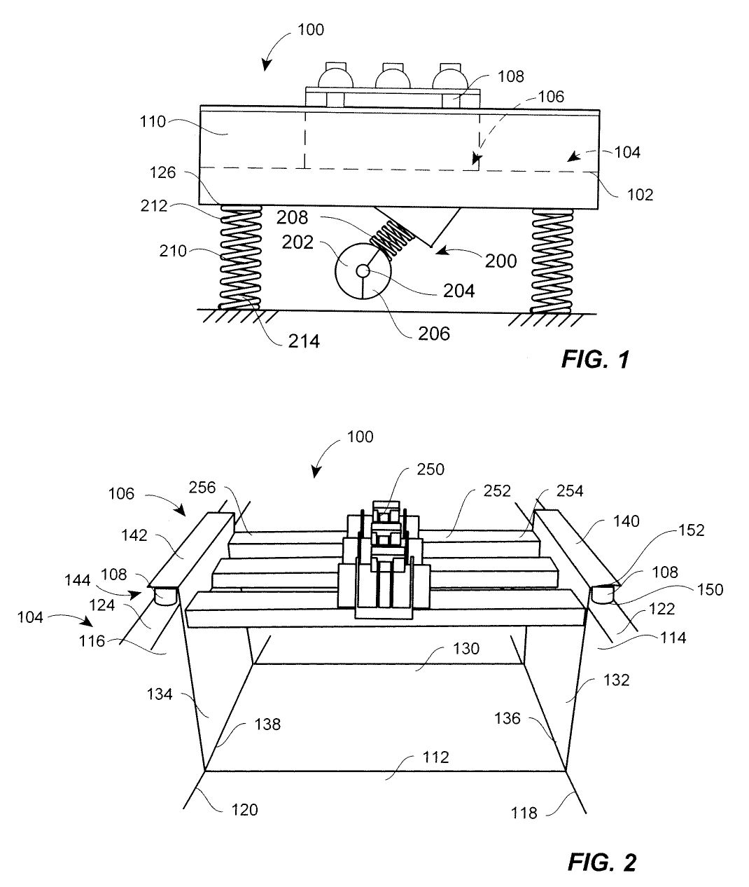

FIGS. 1 and 2 illustrate a first embodiment of a vibratory apparatus 100. The vibratory apparatus includes a deck 102 having a first deck section 104 and a second deck section 106. The first and second sections 104, 106 are coupled to each other through a resilient coupling 108, which may be in the form of one or more resilient members.

In particular, the apparatus 100 includes a trough 110 having a deck plate 112 supported between opposing side walls 114, 116. In particular, the side walls 114, 116 of the trough 110 have a first end 118, 120 attached to the deck plate 112 of the trough 110 and a second, opposite end 122, 124 defining a flange. The deck plate 112 of the trough 110 defines the first deck section 104 of the deck 102. The trough may also have a bottom 126, although this need not be the case according to all embodiments; wherein the deck sections 104 and/or 106 are defined by a screen, for example, the bottom 126 may be used to collect the materials passing through the screens.

The second deck section 106 has a deck plate 130 supported between opposing side walls 132, 134. The side walls 132, 134 of the second deck section 106 have a first end 136, 138 attached to the deck plate 130 and a second, opposite end 140, 142 defining a flange. The flanges 122, 124 of the side walls 114, 116 of the trough 110 face and are disposed apart from the flanges 140, 142 of the side walls 132, 134 of the second deck section 106 to define a space 144 therebetween.

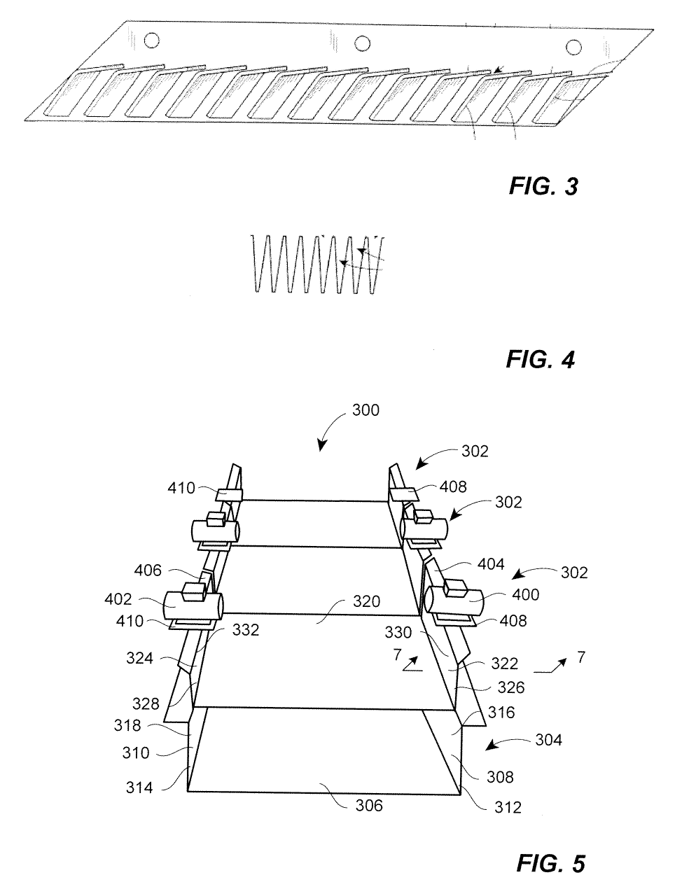

According to the illustrated embodiment of FIGS. 1 and 2, the deck plate 130 of the second deck section 106 may be defined by a finger screen, as illustrated in FIGS. 3 and 4. However, it is also possible for the second deck section 106 to include, in whole or in part, structures other than the finger screen. For example, the deck plate 130 of the second deck section 106 may be defined by a solid plate, or other screening or separating structure. In a similar fashion, the deck plate 112 may be a screen or a solid plate.

As mentioned above, one or more resilient members 108 are coupled between the first and second sections 104, 106. As illustrated, the resilient members 108 each have a first end 150 abutting one of the side walls 114, 116 of the trough 110 and a second end 152 abutting one of the side walls 132, 134 of the second deck section 106. Specifically, the resilient members 108 may be disposed in the space 144 between the flanges 122, 124 of the side walls 114, 116 of the trough 110 and the flanges 140, 142 of the side walls 132, 134 of the second deck section 106. The resilient members 108 may be held in place by bolts passed through the flanges 122, 124, 140, 142 and the resilient members 108.

As illustrated, the resilient members 108 may be an elastomer spring. It will be recognized that the resilient members 108 may be defined by other structures, such as coil springs, for example.

The vibratory apparatus 100 includes a primary vibratory generator 200 coupled to the first and second sections 104, 106 of the deck 102. The primary vibratory generator 200 may be a brute force, two-mass, or other generator. As illustrated, the primary vibratory generator 200 is a two-mass generator, including a motor 202 having a motor shaft 204 with eccentric masses 206, which motor 202 is attached to the trough 110 through one or more resilient members 208, such as coil springs.

Additionally, the vibratory apparatus 100 may include resilient isolators 210. The isolators 210 each having a first end 212 coupled to the trough 110 and a second end 214 coupled to ground. The isolators 210 act to limit the transmission of vibrations from the vibratory apparatus 100 to the surrounding environment. The resilient isolators 210 may be coil springs, as illustrated.

The vibratory apparatus 100, as illustrated, further includes a plurality of secondary vibratory generators 250 coupled to only the second deck section 106 of the deck 102. As illustrated, the second deck section 106 includes a plurality of cross-members 252, each having a first end 254 coupled to one of the opposing sidewalls 132, 134 and a second end 256 coupled to the other of the opposing sidewalls 132, 134. Each of the secondary vibratory generators 250 is then coupled to one of the cross-members 252. It will be recognized that while three generators 250 are illustrated in FIG. 2, the number of generators 250 may vary, such that one, two or more vibratory generators 250 may be used in a given embodiment.

In operation, the primary vibratory generator 200 operates a first frequency and a first amplitude. This induces a first motion in the material passing along the deck 102, moving the material in a series of “catches and throws.” By contrast, the secondary vibratory generator 250 operates at a second frequency and a second amplitude, the second frequency preferably being higher than the first frequency and the second amplitude preferably being smaller than the first amplitude. This induces a second motion in the material passing along the second deck section 106 of the deck 102, limiting adhesion of the material to the second deck section 106 of the deck 102. This may have the added effect of causing materials that have become wedged into the screen that defines the deck plate 130 of the second deck section 106 to release from the screen. According to certain embodiments, the second frequency and amplitude are selected with reference to the frequency of operation of the primary vibratory generator 200 to prevent interference with the motion of the material in the trough 110 caused by the primary vibratory generator.

As noted above, the vibratory apparatus according to the present disclosure may include a number of different embodiments. A further embodiment of the vibratory apparatus 300 according to the present disclosure is illustrated in FIGS. 5-7. It will be recognized that features of the apparatus 300 illustrated in FIGS. 5-7 may be used with features of the apparatus 100 illustrated in FIGS. 1 and 2, and vice versa; for example, the resilient coupling of FIGS. 1 and 2 may be used with the arrangement of vibratory generators of FIGS. 5-7. It will also be recognized that while the embodiment of FIGS. 1 and 2 includes a deck having different first and second sections, the deck of the embodiment of FIGS. 5-7 is defined by a series of similarly structured sections, illustrating that both such arrangements are within the scope of the present disclosure.

Referring first to FIG. 5, the illustrated vibratory apparatus 300 includes a plurality of deck sections 302, each of which operates similar to the second deck section 106 described above. The deck sections 302 are supported above a trough 304 having a bottom 306 with opposing side walls 308, 310. The side walls 308, 310 have a first end 312, 314 attached to the bottom 306 of the trough 304 and a second end 316, 318. In a similar fashion, each deck section 302 includes a deck plate 320 and opposing side walls 322, 324. The side walls 322, 324 have a first end 326, 328 attached to the deck plate 320 of the section, and a second end 330, 332. A flexible flap, such as may be formed of rubber, for example, may be disposed between the deck sections 302 as a transfer piece to permit transition of the material passing along the surfaces 320 from one deck section 302 to the next.

According to the illustrated embodiment of FIGS. 5-8, the deck plate 320 of the deck sections 302 may be defined by a finger screen, as illustrated in FIGS. 3 and 4. However, it is also possible for the deck sections 302 to include, in whole or in part, structures other than the finger screen. For example, the deck plate 320 of the deck section 302 may include a solid plate, or other screening or separating structure.

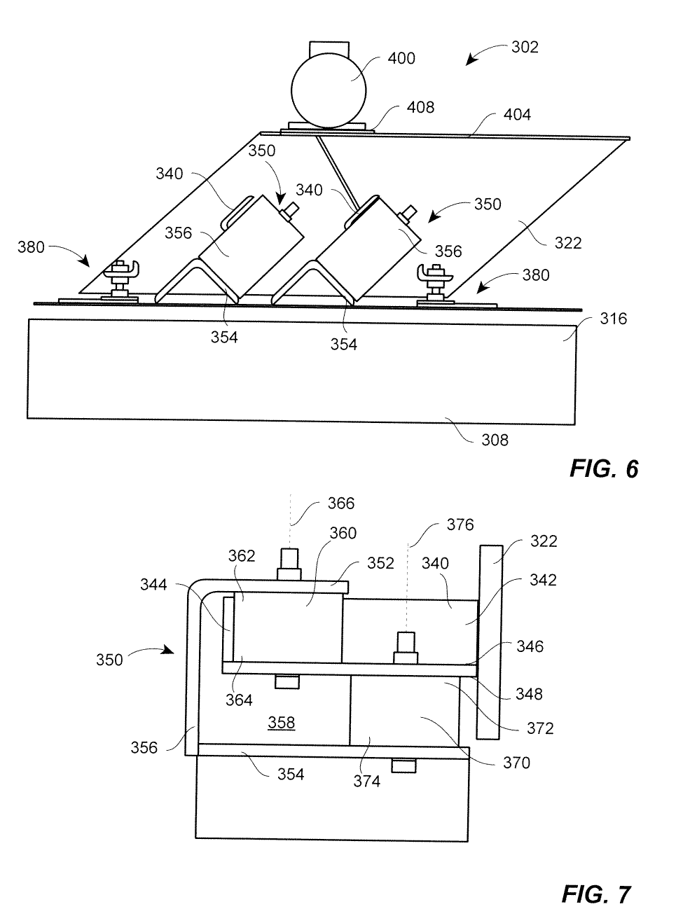

The deck sections 302 are supported above the trough 304 through one or more resilient couplings. As illustrated in FIGS. 6 and 7, the resilient couplings are defined between respective ones of the side walls 308, 310 of the trough 304 and sidewalls 322, 324 of the deck section 302. As illustrated in FIG. 6, more than one coupling may be associated with the side walls 308, 322 and 310, 324; it will be recognized that a greater or a lesser number of couplings may be present in a given embodiment than are illustrated in FIG. 6.

The couplings are defined by certain structures attached to the side walls 308, 310 of the trough 304 and by certain structures attached to the side walls 322, 324 of the deck section 302. As illustrated in FIGS. 6 and 7, the structures are attached to the side wall 308 of the trough 304 and the side wall 322 of the deck section 302. It will be recognized that a similar arrangement exists on the other side of the apparatus 300 relative to the side wall 310 of the trough 304 and the side wall 324 of the deck section 302.

In particular, the coupling may include a cantilevered beam 340, which may be defined by an L-shaped angle, that is attached at one end 342 to the side wall 322 of the deck section 302 and has a second, free end 344. The cantilevered beam 340 also has first and second opposing surfaces 346, 348. Likewise, a U-shaped frame 350 is attached to the side wall 308 of the trough 304, the U-shaped frame 350 having first and second legs 352, 354 and a bight 356 that connects the legs 352, 354. The second leg 354, like the beam 340, may be defined by an L-shaped angle with ends that are attached to the second end 316 of the wall 308 of the trough 304, by welding, for example. See FIG. 6. The legs 352, 354 and the bight 356 bound a space 358 in which the cantilevered beam 340, or at least the second end 344, depends.

A pair of resilient members is attached between the structures attached to the side wall 308 of the trough 304 and to the side wall 322 of the deck section 302. As illustrated, a first resilient member 360 is disposed between the first leg 352 and the first surface 346 of the cantilevered beam 340, while a second resilient member 370 is disposed between the second surface 348 of the cantilevered beam 340 and the second leg 354. According to an embodiment, the first resilient member 360 may have a first end 362 abutting the first leg 352, and a second end 364 abutting the first surface 346 of the cantilevered beam 340. Similarly, the second resilient member 370 may have a first end 372 abutting the second surface 348 of the cantilevered beam 340, and a second end 374 abutting the second leg 354. It will be recognized, however, that according to other embodiments, one or more spaces may exist between the resilient members 360, 370, the beam 340 and legs 352, 354. The resilient members 360, 370 may be secured in place by bolts that pass along a longitudinal axis 366 of the first resilient member 360 and a longitudinal axis 376 of the second resilient member 370.

As illustrated, the longitudinal axis 366 of the first resilient member 360 is offset, or spaced, from the longitudinal axis 376 of the second resilient member 370; it will be recognized that the axes 366, 376 may instead be aligned with each other. Also, as illustrated, the first and second resilient members 360, 370 are elastomer springs; it will be recognized that other forms of resilient member may also be used, such as coil springs.

Additionally, stabilizers may be used in conjunction with the deck sections 302 to reduce any motions of the deck sections 302 in undesired directions. For example, as illustrated, two stabilizer or stabilizer assemblies 380 may be attached to the deck section 302 at its ends. These stabilizers 380 may reduce a tendency of the deck section 302 to move about a longitudinal axis. However, it will also be recognized that the stabilizers 380 need not be included in all embodiments according to the present disclosure, and thus are optional.

The vibratory apparatus 300 also includes opposed pairs of vibratory generators 400, 402 in the place of the centrally located vibratory generators 250 illustrated in the embodiment of FIGS. 1 and 2. Each one of the vibratory generators 400, 402 is attached to one of the opposing side walls 322, 324 of the deck section 302. More particularly, the side walls 322, 324 of the deck section 302 each have a flange 404, 406 formed at one of the second ends 330, 332. Each flange 404, 406 has a mounting plate 408, 410 attached thereto, and the generators 400, 402 are attached to the mounting plates 408, 410.

In operation, the apparatus 300 functions much like the apparatus 100. That is, a primary vibratory generator (not shown) associated with the trough 304 operates a first frequency and a first amplitude. This induces a first motion in the material passing along the deck sections 302, moving the material in a series of “catches and throws.” By contrast, the vibratory generators 400, 402 operate at a second frequency and a second amplitude, the second frequency preferably being higher than the first frequency and the second amplitude preferably being smaller than the first amplitude. This induces a second motion in the material passing along the deck sections 302, limiting adhesion of the material to the deck section 302. This may have the added effect of causing materials that have become wedged into the screen that defines the deck plate 320 of the deck section 302 to release from the screen. According to certain embodiments, the second frequency and amplitude are selected with reference to the frequency of operation of the primary vibratory generator to prevent interference with the motion of the material along the deck sections 302 caused by the primary vibratory generator.

It is believed that the present disclosure may have several benefits, one or more of which may be present in a particular embodiment according to the present disclosure.

For one thing, the adhesion of material to the deck sections 106, 302 may be inhibited without resort to an anti-stick coating on the deck sections 106, 302. As a consequence, the concerns regarding objects passing over the deck sections 106, 302 causing damage to or removal of the coating are reduced. Further, because an anti-stick coating is no longer necessary, the repair and/or replacement of the coating over time are lesser factors. Moreover, the cost of applying a coating to the surface in the first instance may be eliminated, or may become an optional adjunct to use of the mechanism according to the present disclosure.

In addition, according to certain embodiments of the present disclosure, the action of the secondary vibratory generators may cause the motion of the material across the deck sections 106, 302 to advantageously reverse direction. That is, referring to FIG. 1, for example, the motion of material along the deck 102 may be in the direction from left to right as illustrated. However, when the primary vibratory generator 200 is deactivated, but the secondary vibratory generators 250 are operated, the movement of materials across the deck plate 130 may be from right to left. As a consequence, fine materials may have a tendency to pass through the gaps between successive sets of fingers where the finger screen is oriented as shown in FIG. 3. It is believed that this advantageous effect may also occur when the primary vibratory generator 200 is activated.

We claim:

1. A vibratory apparatus comprising:
a trough having side walls;
a deck section having a deck plate defining at least in part a deck and side walls, the side walls of the deck section resiliently coupled to the side walls of the trough;
a primary vibratory generator coupled to the trough, the primary vibratory generator operating a first frequency and a first amplitude; and
a secondary vibratory generator coupled to the deck section, the secondary vibratory generator operating at a second frequency and a second amplitude, the second frequency being higher than the first frequency and the second amplitude being smaller than the first amplitude.

2. The vibratory apparatus according to claim 1, wherein the trough comprises a deck plate supported between the side walls, the deck plate of the trough defining at least in part the deck.

3. The vibratory apparatus according to claim 1, further comprising a resilient member disposed between one of the side walls of the trough and one of the side walls of the deck section.

4. The vibratory apparatus according to claim 1, further comprising:
a cantilevered beam attached at one end to one of the side walls of the deck section, the cantilevered beam having first and second opposing surfaces;
a U-shaped frame attached to one of the side walls of the trough, the U-shaped frame having first and second legs and a bight that bound a space in which the cantilevered beam depends;
a first resilient member disposed between the first leg and the first surface of the cantilevered beam; and
a second resilient member disposed between the second surface of the cantilevered beam and the second leg.

5. The vibratory apparatus according to claim 4, wherein the first resilient member has a longitudinal axis and the second resilient member has a longitudinal axis, and the longitudinal axis of the first resilient member is offset from the longitudinal axis of the second resilient member.

6. The vibratory apparatus according to claim 5, wherein the resilient member is an elastomer spring.

7. The vibratory apparatus according to claim 1, wherein
the side walls of the trough have a first end attached to the deck plate of the trough and a second, opposite end defining a flange,
the side walls of the deck section have a first end attached to the deck plate and a second, opposite end defining a flange, the flanges of the side walls of the trough facing and disposed apart from the flanges of the side walls of the deck section to define a space therebetween, and
a resilient member is disposed in the space between the flanges of the side walls of the trough and the flanges of the side walls of the deck section.

8. The vibratory apparatus according to claim 7, wherein the resilient member is an elastomer spring.

9. The vibratory apparatus according to claim 1, further comprising a pair of vibratory generators, each one of the vibratory generators attached to one of the opposing side walls.

10. The vibratory apparatus according to claim 9, wherein the side walls of the deck section have a first end attached to the deck plate and a second, opposite end defining a flange, and further comprising a pair of vibratory generators, each one of the vibratory generators attached to a flange of one of the opposing side walls.

11. The vibratory apparatus according to claim 1, wherein the second section comprise a cross-member having a first end coupled to one of the opposing side walls and a second end coupled to the other of the opposing side walls, the secondary vibration generator coupled to the cross-member.

12. The vibratory apparatus according to claim 1, wherein the deck plate of the deck section comprises a finger screen.

13. The vibratory apparatus according to claim 1, further comprising resilient isolators each having a first end coupled to the trough and a second end coupled to ground.

14. The vibratory apparatus according to claim 13, wherein the resilient isolators are coil springs.
